(19) United States
(12) Patent Application Publication
(10) Pub. No.: US 2015/0269135 A1
(43) Pub. Date: Sep. 24, 2015

(54) LANGUAGE IDENTIFICATION FOR TEXT IN AN OBJECT IMAGE

(71) Applicant: QUALCOMM Incorporated, San Diego, CA (US)

(72) Inventors: Duck-Hoon Kim, Seoul (KR); Seungwoo Yoo, Seoul (KR); Jihoon Kim, Seoul (KR)

(73) Assignee: QUALCOMM Incorporated, San Diego, CA (US)

(21) Appl. No.: 14/219,903

(22) Filed: Mar. 19, 2014

(51) Int. Cl. G06F 17/27; G06K 9/18; G06F 17/22

(52) U.S. Cl. CPC G06F 17/275; G06F 17/2276; G06F 17/2735; G06K 9/18

(57) ABSTRACT

A method, performed by an electronic device, for identifying a language of text in an image of an object is disclosed. In this method, the image of the object is received. The method includes detecting a text region in the image that includes the text and identifying a script of the text in the text region that is associated with a plurality of languages. Based on the plurality of languages associated with the script, the language for the text is determined.

### TECHNICAL FIELD

The present disclosure relates generally to image processing, and more specifically, to processing an image of an object in electronic devices.

### BACKGROUND

Modern electronic devices such as mobile phones, tablet computers, and the like often provide a variety of functions for processing various types of data such as image data, sound data, etc. Some electronic devices may be equipped with image processing capabilities to convert a photograph into another form of data. For example, an electronic device may process a photograph to recognize various objects in the photograph.

Images that are processed by conventional electronic devices often include text. For processing text in images, conventional electronic devices may include a text recognition function to recognize various characters in the images. For example, an optical character recognition function in such electronic devices may recognize characters of text in an image. Once characters in an image are recognized, the electronic devices may detect a string of characters in the image as a word and determine the meaning of the word.

In determining the meaning of a string of characters, conventional electronic devices may allow a user to select a language associated with the string of characters. Based on the language selected by the user, the string of characters may be determined to be a word of the selected language and processed to determine the meaning of the word. However, such a manual selection may be time-consuming or inconvenient to the user. Further, if the user is not familiar with the language of the characters or the string of characters, he or she may not be able to provide language information.

### SUMMARY

The present disclosure relates to determining a language for text in a text region based on a plurality of languages associated with an identified script.

According to one aspect of the present disclosure, a method, performed by an electronic device, for identifying a language of text in an image of an object is disclosed. In this method, the image of the object is received. The method includes detecting a text region in the image that includes the text and identifying a script of the text in the text region that is associated with a plurality of languages. Based on the plurality of languages associated with the script, the language for the text is determined This disclosure also describes apparatus, a device, a combination of means, and a computer-readable medium relating to this method.

According to another aspect of the present disclosure, an electronic device for identifying a language of text in an image of an object includes a text region detection unit, a script identification unit, and a language determination unit. The text region detection unit is configured to receive the image of the object and detect a text region in the image that includes the text. The script identification unit is configured to identify a script of the text in the text region that is associated with a plurality of languages. The language determination unit is configured to determine the language for the text based on the plurality of languages associated with the script.

### BRIEF DESCRIPTION OF THE DRAWINGS

Embodiments of the inventive aspects of this disclosure will be understood with reference to the following detailed description, when read in conjunction with the accompanying drawings.

FIG. 1 illustrates an electronic device configured to capture an image of an object including text and determine a language of the text according to one embodiment of the present disclosure.

FIG. 2 is a block diagram of the electronic device configured to receive an image of an object including text and determine a language of the text according to one embodiment of the present disclosure.

FIG. 3 is a flowchart of a method for determining a language of text in an image of an object that includes the text according to one embodiment of the present disclosure.

FIG. 4 illustrates a diagram of a script database that associates a plurality of exemplary scripts with one or more languages according to one embodiment of the present disclosure.

FIG. 5 is a block diagram of a script identification unit configured to receive a text region including text and identify a script of the text according to one embodiment of the present disclosure.

FIG. 6 illustrates a flow diagram of a method for identifying a script for a text region by accessing a plurality of probability models in a storage unit according to one embodiment of the present disclosure.

FIG. 7 is a flowchart of a method for identifying a script of text in a text region based on at least one feature for the text region and a probability model database according to one embodiment of the present disclosure.

FIG. 8 is a block diagram of a language determination unit configured to determine a language of the text in a text region based on a plurality of languages associated with an identified script according to one embodiment of the present disclosure.

FIG. 9 is a diagram of an exemplary dictionary database for a plurality of Latin-based languages that may be used in determining a language for a word according to one embodiment of the present disclosure.

FIG. 10 illustrates a diagram of an exemplary finite state transducer that may be implemented in a language identification unit for identifying a plurality of Latin-based languages according to one embodiment of the present disclosure.

FIG. 11 is a flowchart of a method for determining a language of text based on a dictionary database associated with an identified script according to one embodiment of the present disclosure.

FIG. 12 illustrates a block diagram of an exemplary electronic device in which the methods and apparatus for identifying a language of text in an image of an object may be implemented, according to one embodiment of the present disclosure.

### DETAILED DESCRIPTION

Reference will now be made in detail to various embodiments, examples of which are illustrated in the accompanying drawings. In the following detailed description, numerous specific details are set forth in order to provide a thorough understanding of the present subject matter. However, it will be apparent to one of ordinary skill in the art that the present subject matter may be practiced without these specific details. In other instances, well-known methods, procedures, systems, and components have not been described in detail so as not to unnecessarily obscure aspects of the various embodiments.

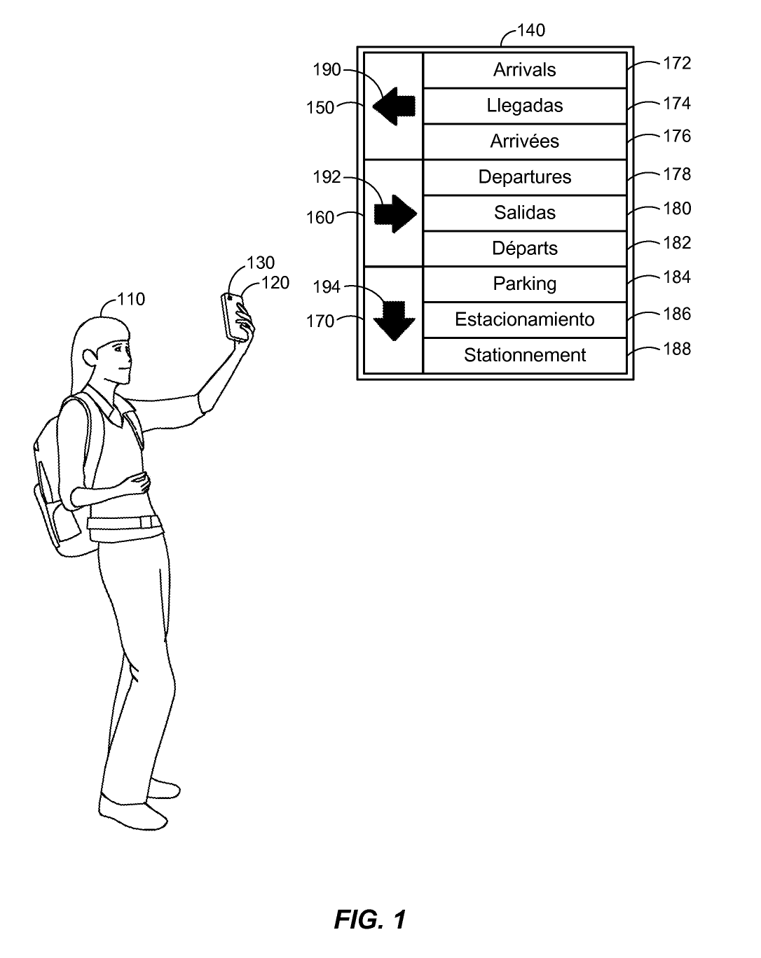

FIG. 1 illustrates an electronic device 120 configured to capture an image of an object 140 including text and determine a language of the text according to one embodiment of the present disclosure. As illustrated, the object 140 is a sign that includes a plurality of text regions 172, 174, 176, 178, 180, 182, 184, 186, and 188, each of which includes text. Although the object 140 is illustrated as a sign, it may be any tangible thing or item that includes or shows text. The object 140 includes a plurality of regions 150, 160, and 170 for indicating an arrival area, a departure area, and a parking area, respectively.

The regions 150, 160, and 170 in the object 140 may include a plurality of arrows, 190, 192, and 194, respectively, which indicates a direction to the arrival area, the departure area, and the parking area, respectively. The regions 150, 160, and 170 may include text indicating the arrival area, the departure area, and the parking area, respectively, in a plurality of languages including English, Spanish, and French. For example, the region 150 indicating the arrival area may include a plurality of text regions 172, 174, and 176 indicating the arrival area as “Arrivals,” “Llegadas,” and “Arrivées,” in English, Spanish, and French, respectively. Similarly, the region 160 for the departure area may include a plurality of text regions 178, 180, and 182, which indicates the departure area as “Departures,” “Salidas,” and “Départs,” in English, Spanish, and French, respectively. Likewise, the region 170 for the parking area may include a plurality of text regions 184, 186, and 188 indicating the parking area as “Parking,” “Estacionamiento,” and “Stationnement,” in English, Spanish, and French, respectively.

In the illustrated embodiment, a user 110 may operate the electronic device 120 equipped with an image sensor 130 to capture an image of the object 140 for determining one or more languages for text in the text regions 172 to 188 in the object 140. From the captured image of the object 140, the electronic device 120 may detect the text regions 172 to 188 that include text. For example, the text regions 172, 174, and 176 for “Arrivals,” “Llegadas,” and “Arrivées” may be detected in the image.

Upon detecting the text regions 172, 174, and 176, the electronic device 120 may identify a script of the text in each of the text regions 172, 174, and 176 based on at least one feature extracted from the associated text region. As used herein, the term “script” refers to a writing system based on a set of characters, letters, and/or symbols that may be used in or associated with one or more languages. For example, the Latin script, also referred to as Roman script, is used in a plurality of languages including English, Spanish, French, German, Italian, etc. In the illustrated embodiment, the characters in the text “Arrivals,” “Llegadas,” and “Arrivées” in the text regions 172, 174, and 176 are Latin characters. Accordingly, the script for the text regions 172, 174, and 176 may be identified as being Latin.

The electronic device 120 may determine a language for each text in the text regions 172, 174, and 176 based on one or more languages associated with the identified script. In one embodiment, one or more characters in each text of the text regions 172, 174, and 176 may be recognized, and a language for the characters may be identified based on a dictionary database for the one or more languages associated with the identified script. For example, the electronic device 120 may recognize the characters in the text “Arrivals” in the text region 172 and identify the language of the text as being English based on a dictionary database that includes words for the identified Latin script. The language of the text in other text regions 174 and 176 may be determined in a similar manner. Based on the identification of the languages, the electronic device 120 may recognize the text in the text regions 172, 174, and 176 and/or translate the text into another language.

If a text region includes text that is used in a plurality of languages, the electronic device 120 may determine the plurality of languages or perform context analysis to select one of the languages. For example, the language of the text “Parking” in the text region 184 may be determined to be English and French. In this case, the electronic device 120 may identify both languages or analyze one or more other text regions in the image to determine that the language for the text is English.

In some embodiments, one or more text regions in the image may be selected for determining a script and a language. For example, the user 110 may input a command to the electronic device 120 to select one or more text regions. Alternatively, the electronic device 120 may be configured such that one or more text regions laying in a specified region in the image may be automatically selected for determining a script and a language.

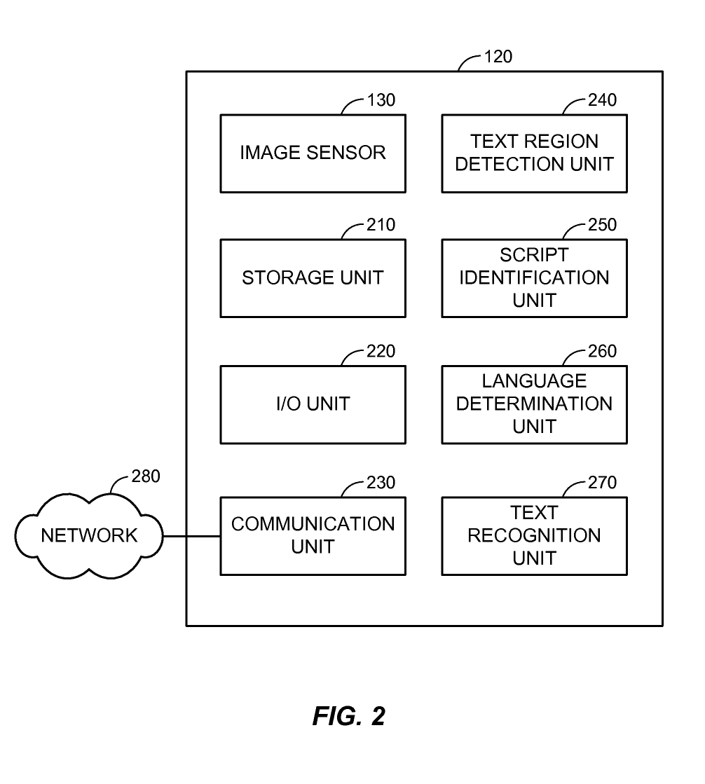

FIG. 2 is a block diagram of the electronic device 120 configured to receive an image of an object including text and determine a language of the text according to one embodiment of the present disclosure. As used herein, the term “receiving” means obtaining or acquiring an object or data item and capturing a data representation of such an object. The electronic device 120 may include the image sensor 130, a storage unit 210, an I/O unit 220, a communication unit 230, a text region detection unit 240, a script identification unit 250, a language determination unit 260, and a text recognition unit 270. As illustrated herein, the electronic device 120 may be any suitable device equipped with an image processing capability such as a wearable computer (e.g., smart glasses, a smart watch, etc.), a cellular phone, a smartphone, a personal computer, a laptop computer, a tablet computer, a gaming device, a multimedia player, etc.

The image sensor 130 may be configured to capture an image of an object such as a sign or a document including text. The image sensor 130 can be any suitable device that can be used to capture, sense, and/or detect an image of an object. Additionally or alternatively, an image of an object including text may be received from an external storage device via the I/O unit 220 or through the communication unit 230 via an external network 280.

One or more images including text may be stored in the storage unit 210 for use in determining a language of the text. The images may include one or more text regions, each of which includes text. The storage unit 210 may also store a probability model database associated with a plurality of scripts for use in identifying a script for text in the script identification unit 250. In one embodiment, the probability model database may include a probability model for each of the plurality of scripts to indicate a probability that given text is associated with the script. Additionally, the storage unit 210 may store a character information database that may be used for recognizing a plurality of characters associated with a plurality of scripts. For each script, the character information database may include patterns or geometric data of a plurality of characters used in the script, images of glyphs representing a plurality of characters in the script, and/or at least one feature associated with each individual glyph in the script.

The storage unit 210 may also store a script database associating a plurality of scripts with a plurality of languages that may be used in determining one or more languages associated with an identified script. In addition, the storage unit 210 may also store a dictionary database for a plurality of languages associated with a plurality of scripts for use in determining a language for text in the language determination unit 260. In one embodiment, the dictionary database may include a plurality of words mapped to the plurality of languages. The storage unit 210 may be implemented using any suitable storage or memory devices such as a RAM (Random Access Memory), a ROM (Read-Only Memory), an EEPROM (Electrically Erasable Programmable Read-Only Memory), a flash memory, or an SSD (solid state drive).

The I/O unit 220 may receive commands from the user 110 and/or output information for the user 110. For example, the I/O unit 220 may receive a command from the user 110 to capture an image of an object and determine a language for text in the image. The language determined for the text may be displayed via the I/O unit 220. In some embodiments, the I/O unit 220 may be a touch screen, a keypad, a touchpad, a display, or the like.

The text region detection unit 240 may be configured to receive images of objects that include text and detect one or more text regions in the images. In one embodiment, a text region in an image may be detected by determining one or more blobs for individual characters in the text region. One or more blobs having one or more similar properties such as a color, intensity, proximity, and the like may be clustered in a blob clustering operation. For example, a plurality of blobs having a same color and located in proximity may be clustered into a blob cluster. A text extraction operation may be performed on the blob cluster to detect a text region that includes text. The text region containing text may be detected based on any suitable text region detection schemes such as an edge based method, a connected-component based method, a texture based method, or the like. In some embodiments, each blob cluster may also be corrected for skew and filtered to remove artifacts. In addition, a blob cluster in color or gray scale may be converted into a black and white blob cluster.

The script identification unit 250 may receive one or more text regions detected in the text region detection unit 240 and identify a script for the text in each of the text regions. In one embodiment, one or more features may be extracted from each of the text regions. The script identification unit 250 may identify a script for each of the text regions by generating a classification score for each of the plurality scripts based on the extracted features and the probability model database from the storage unit 210. A script ID, which is an identifier for identifying the script for each of the text regions, may then be provided to the language determination unit 260.

The language determination unit 260 may be configured to receive one or more script IDs for the detected text regions from the script identification unit 250 and determine a language for the text in each of the text regions. For each of the text regions detected in the text region detection unit 240, the language determination unit 260 may recognize one or more characters in the text region. In this process, the language determination unit 260 may access the character information database in the storage unit 210 that is associated with the script identified for the text region. The recognized characters for each of the text regions may then be used to determine a language for the text in the text region based on the dictionary database for the plurality of languages associated with the identified script. In one embodiment, the language determination unit 260 may output an image of the object via the I/O unit 220 by indicating the determined languages for the one or more text regions in the image.

In some embodiments, the text recognition unit 270 may be configured to receive one or more languages determined in the language determination unit 260 and the associated text regions, and perform text recognition on the text regions based on the identified languages. Additionally, the recognized text for the text regions may be translated into one or more other languages. The recognized or the translated text may be stored in the storage unit 210 or transmitted to another electronic device via the communication unit 230.

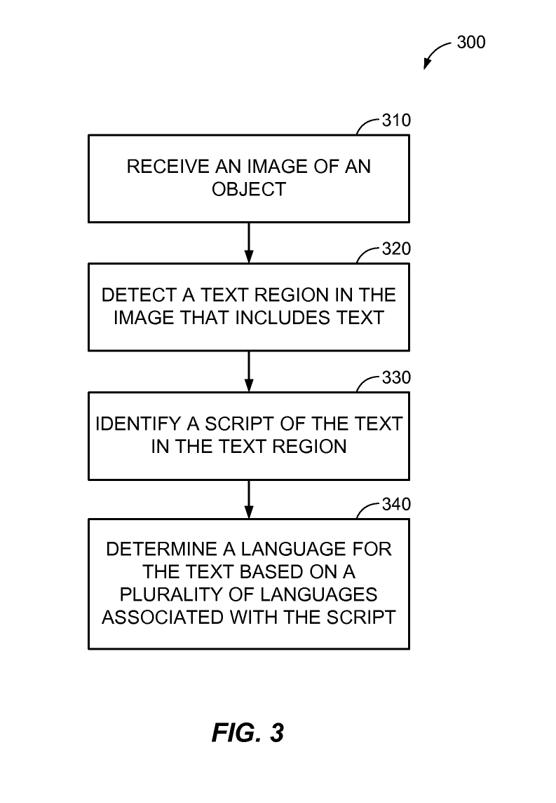

FIG. 3 is a flowchart of a method 300 for determining a language of text in an image of an object that includes the text according to one embodiment of the present disclosure. Initially, the electronic device 120 may receive the image of the object from at least one of the storage unit 210, the I/O unit 220, and the communication unit 230, at 310. Once the image of the object is received, the text region detection unit 240 may detect one or more text regions in the object image, at 320.

At 330, the script identification unit 250 may identify a script of the text in each of the text regions. In this process, one or more features may be extracted from each of the text regions and a probability model database associated with a plurality of scripts may be retrieved from the storage unit 210. The language determination unit 260 may receive one or more script IDs for the detected text regions from the script identification unit 250 and determine a language for the text in each of the text regions based on a plurality of languages associated with the script ID identified for the text region, at 340.

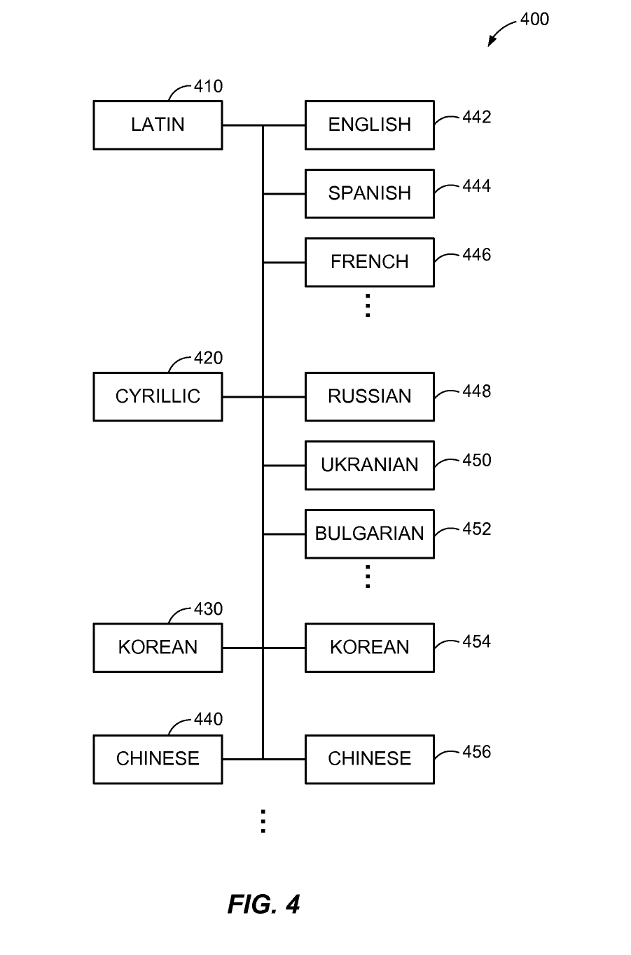

FIG. 4 illustrates a diagram of a script database 400 that associates a plurality of exemplary scripts 410, 420, 430, and 440 with one or more languages 442, 444, 446, 448, 450, 452, 454, and 456 according to one embodiment of the present disclosure. As shown, the script database 400 includes the plurality of scripts, Latin script 410, Cyrillic script 420, Korean script 430, and Chinese script 440. In the script database 400, the Latin script 410 may be associated with a plurality of languages including English language 442, Spanish language 444, French language 446, etc. On the other hand, the Cyrillic script 420 may be associated with a plurality of languages including Russian language 448, Ukrainian language 450, Bulgarian language 452, etc. The Korean script 430 and the Chinese script 440 are associated with Korean language 454 and Chinese language 456, respectively. Although the script database 400 illustrates the scripts 410, 420, 430, and 440, it may also include a plurality of other scripts that are associated with one or more other languages. The script database 400 may be implemented using any suitable data structures such as a linked list, an array, a hash table, etc.

The electronic device 120 may store the script database 400 in the storage unit 210 for use in determining a language for an identified script. Upon receiving a script ID for a text region from the script identification unit 250, the language determination unit 260 may access the script database 400 and identify one or more languages associated with the identified script (i.e., the script ID). The language determination unit 260 may then access the dictionary database in the storage unit 210 that is associated with the identified languages. According to one embodiment, the dictionary database may include a plurality of dictionaries for a plurality of languages. In this case, the language determination unit 260 may determine a language for the text region by accessing a dictionary for each of the identified languages.

With reference to FIG. 4, if an identified script for text in a text region is the Latin script 410, the language determination unit 260 may determine that the English, Spanish, and French languages 442, 444, and 446 are associated with the Latin script 410 based on the script database 400. On the other hand, if the identified script is associated with only one language in the case of the Korean script 430 or the Chinese script 440, the language for the text in the text region may be determined from the script itself or the associated language in the script database 400. In some embodiments, the identified script may also be output via the I/O unit 220 for the user 110.

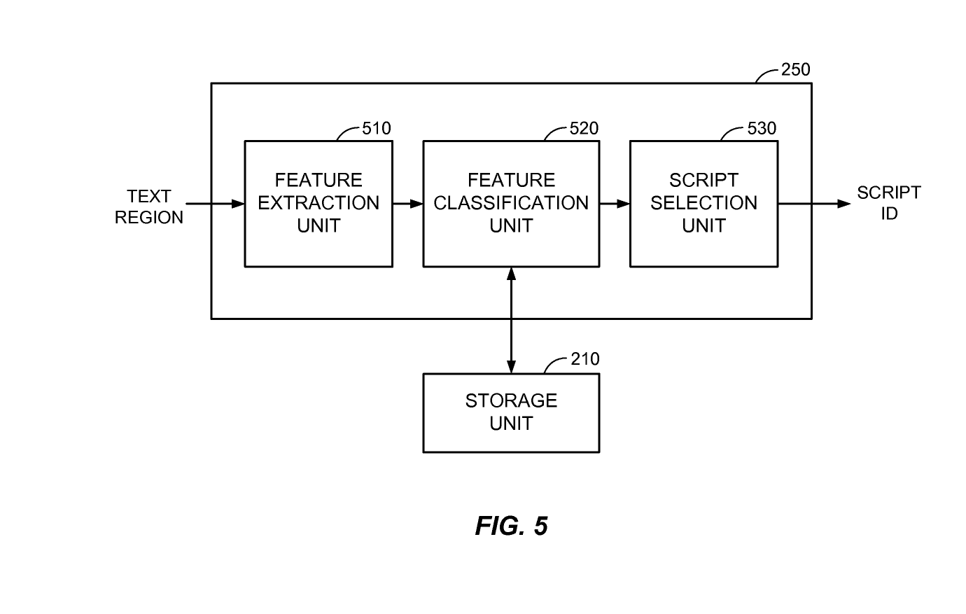

FIG. 5 is a block diagram of the script identification unit 250 configured to receive a text region including text and identify a script of the text according to one embodiment of the present disclosure. The script identification unit 250 may include a feature extraction unit 510, a feature classification unit 520, and a script selection unit 530. Although the script identification unit 250 is shown to receive and process the text region, it may also receive and process a plurality of text regions sequentially or in parallel.

In the script identification unit 250, the feature extraction unit 510 may receive the text region from the text region detection unit 240 and extract one or more features from the text region. The features may be extracted from the text region by using any suitable feature extraction techniques such as an edge detection technique, a scale-invariant feature transform technique, a template matching technique, a Hough transform technique, etc. In some embodiments, one or more features that are extracted from the text region may be represented as a feature vector.

In one embodiment, the features may be extracted from the text region by using a window defined by a specified size and sequentially moving or sliding the window over the text region in an overlapping manner. For example, the window may be sequentially moved from one end of the text region to the other end of the region in a specified increment such that one or more features are extracted from each window. The size of the window and the increments may be adjusted according to desired accuracy or computational complexity. For instance, the size of the window may be set to be equal to the size of the text region or the sliding increment may be set to equal the width of the window, in which case the text region may be segmented into a plurality of regions having the size of the window without an overlap. The one or more features extracted from the text region may then be provided to the feature classification unit 520.

The feature classification unit 520 may be configured to receive one or more features for the text region from the feature extraction unit 510 and generate a plurality of classification scores for a plurality of scripts. From the storage unit 210, the probability model database classifying the plurality of scripts may be accessed for identifying a script in the text region. The probability model database may include a plurality of probability models associated with the plurality of scripts and non-text. A probability model for a script may be represented by a probability distribution function (e.g., a multivariate Gaussian distribution) for features that correspond to the script. On the other hand, the probability model associated with non-text may indicate a probability distribution function for features that do not correspond to a script. A probability model may be generated using any suitable classification method such as SVM (Support Vector Machine), neural network, MQDF (Modified Quadratic Discriminant Function), etc.

In one embodiment, the feature classification unit 520 may generate a classification score for one or more features based on each of the probability models to indicate a probability or a likelihood that the features are associated with the probability model. For example, four classification scores may be generated based on the probability models for the Latin script 410, the Cyrillic script 420, the Korean script 430, and the Chinese script 440, respectively, to indicate a probability that the features are associated with each of the probability models. Additionally, a classification score for the features may be generated based on the probability model for non-text to indicate a probability that the features are associated with non-text. The classification scores for the plurality of scripts and non-text may then be provided to the script selection unit 530.

The script selection unit 530 may be configured to select a script among the scripts and non-text based on the classification scores received from the feature classification unit 520. In one embodiment, the script may be selected by identifying the script that is most likely to be associated with the features in the text region. For example, the script having the highest classification score among the scripts may be determined to be the script for the text region. A script ID for identifying the script for each of the text regions may be output to the language determination unit 260. In one embodiment, the script ID may be output as the identified script if the classification score exceeds a predetermined threshold score.

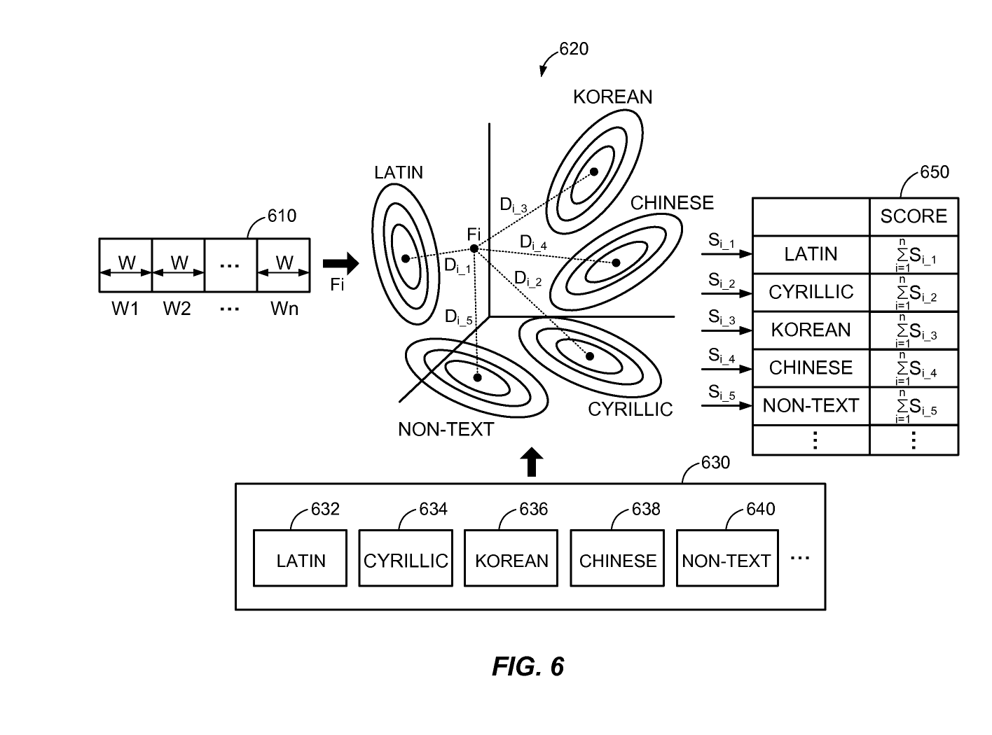

FIG. 6 illustrates a flow diagram 600 of a method for identifying a script for a text region 610 by accessing a probability model database 630 including a plurality of probability models 632, 634, 636, 638, and 640 according to one embodiment of the present disclosure. The method illustrated in the flow diagram 600 may be implemented in the script identification unit 250. The probability model database 630 may be stored in the storage unit 210 or an external storage device. Initially, the feature extraction unit 510 in the script identification unit 250 may receive the text region 610 and determine a plurality of sub-regions W1 to Wn where the integer n indicates the number of sub-regions in the text region 610. In one embodiment, the plurality of sub-regions W1 to Wn may be determined by moving or sliding a window having a window size W over the text region 610 from left to right in an increment of W. Although the sub-regions W1 to Wn are illustrated without an overlap, they may also overlap in part by varying an increment by which the window moves or slides over the text region 610.

From the sub-regions W1 to Wn, the feature extraction unit 510 may extract a plurality of feature vectors F1 to Fn, respectively. In some embodiments, the feature vectors F1 to Fn may be extracted from the sub-regions W1 to Wn, respectively, in sequence or in parallel. Each of the feature vectors F1 to Fn may then be provided to the feature classification unit 520 as a feature vector Fi, where the index i may range from 1 to n.

For each feature vector Fi, the feature classification unit 520 may determine a plurality of classification scores Si_1 to Si_5, where the index i ranges from 1 to n, for a plurality of scripts and non-text by mapping the feature vector Fi to the probability models for the plurality of scripts and non-text. As illustrated, a plurality of classification scores Si_1, Si_2, Si_3, Si_4, and Si_5 may represent scores for the Latin script 410, the Cyrillic script 420, the Korean script 430, the Chinese script 440, and non-text, respectively. In generating the classification scores Si_1 to Si_5 for the feature vector Fi, the feature classification unit 520 may access the probability model database 630. The probability model database 630 may include a plurality of probability models 632, 634, 636, 638, and 640 for associating the feature vector Fi with the Latin script 410, the Cyrillic script 420, the Korean script 430, the Chinese script 440, and non-text, respectively. Although the probability model database 630 is illustrated as including the above probability models, it may also include probability models associated with other scripts.

Based on the probability models 632 to 640, the feature classification unit 520 may associate the feature vector Fi with the plurality of scripts and non-script as shown in a script classification map 620. As shown, the script classification map 620 may be a three-dimensional graph mapping the probability models 632 to 640 for the scripts and non-script. In one embodiment, each of the probability models 632 to 640 may be mapped in the script classification map 620 to indicate a probability distribution according to a multivariate Gaussian distribution. As illustrated in the script classification map 620, the feature classification unit 520 may map the feature vector Fi o the probability models 632 to 640 and determine the classification scores Si_1 to Si_5 for the Latin script 410, the Cyrillic script 420, the Korean script 430, the Chinese script 440, and non-text, respectively.

In one embodiment, a plurality of distances Di_1, Di_2, Di_3, Di_4, and Di_5 (e.g., Euclidean distances) between the feature vector Fi and the probability models 632 to 640, respectively, may be determined for use in determining the classification scores Si_1 to Si_5, respectively. For example, a classification score for a script or non-text may be determined by computing a value that is inversely proportional to a distance between the feature vector Fi and a probability model for the script or non-text. In this case, a script or non-text with the shortest distance between the feature vector Fi and the associated probability model may have the highest classification score. On the other hand, a script or non-text with the longest distance between the feature vector Fi and the associated probability model may have the lowest classification score. The classification scores Si_1 to Si_5 for the scripts 410 to 440 and non-text, respectively, may then be provided to the script selection unit 530.

The script selection unit 530 may receive a set of classification scores Si_1 to Si_5 for each of the sub-regions W1 to Wn in the text region 610. In the illustrated embodiment, given the n sub-regions W1 to Wn, n sets of classification scores Si_1 to Si_5 may be received for the text region 610. As each set of classification scores Si_1 to Si_5 is received, the script selection unit 530 may accumulate each of the classification scores Si_1 to Si_5.

As illustrated, the script selection unit 530 may include a table 650 that is configured to accumulate the classification scores Si_1 to Si_5, where the index i ranges from 1 to n, for the scripts 410 to 440 and non-text, respectively. Upon receiving a first set of classification scores S1_1 to S1_5 for the first sub-region W1, the classification scores S1_1 to S1_5 are accumulated in the associated entries in the table 650. When a second set of classification scores S2_1 to S2_5 is received for the second sub-region W2, the received classification scores S2_1 to S2_5 are added to the existing classification scores in the respective entries in the table 650.

When n sets of classification scores Si_1 to Si_5 for the n sub-regions W1 to Wn have been received and accumulated for the Latin script 410, the Cyrillic script 420, the Korean script 430, the Chinese script 440, and non-text in the table 650, the script selection unit 530 may select one of the Latin script 410, the Cyrillic script 420, the Korean script 430, the Chinese script 440, and non-text that has the highest classification score. For example, if the Latin script 410 has the highest classification score, the Latin script 410 may be selected and output to the language determination unit 260. In some embodiments, the script selection unit 530 may select one of the Latin script 410, the Cyrillic script 420, the Korean script 430, the Chinese script 440 and non-text based on statistical data such as maximum classification scores, mean classification scores, and standard deviations for the scripts 410 to 440, and non-text. In the case of maximum classification scores, a maximum classification score for each of the scripts 410 to 440 and non-text may be determined from n sets of classification scores Si_1 to Si_5 for the n sub-regions W1 to Wn. The script selection unit 530 may then select one of the scripts 410 to 440 and non-text that has the highest maximum classification score as the identified script for the text region 610.

The script selection unit 530 may also determine a mean classification score for each of the Latin script 410, the Cyrillic script 420, the Korean script 430, the Chinese script 440, and non-text based on the accumulated classification scores of the scripts 410 to 440 and non-text. In this case, one of the scripts 410 to 440 and non-text having the highest mean classification score may be selected as the identified script. Alternatively, the script selection unit 530 may determine a standard deviation for the mean classification scores associated with each of the scripts 410 to 440 and non-text and select one of the scripts, 410 to 440, and non-text that has the lowest standard deviation.

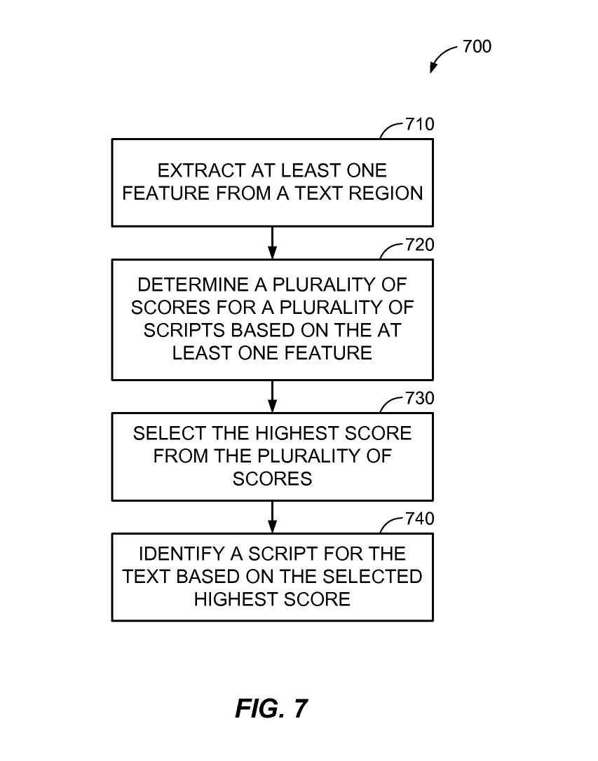

FIG. 7 shows a flowchart of a method 700 for identifying a script of text in a text region based on at least one feature for the text region and a probability model database according to one embodiment of the present disclosure. Initially, the script identification unit 250 may receive the text region from the text region detection unit 240. The feature extraction unit 510 in the script identification unit 250 may extract at least one feature from the text region, at 710.

From the feature extraction unit 510, the feature classification unit 520 in the script identification unit 250 may receive the at least one feature for the text region and determine a plurality of scores for a plurality of scripts, at 720. For the at least one features, the feature classification unit 520 may generate a score for each of a plurality of probability models associated with the plurality of scripts. The score may indicate a probability or a likelihood that the at least one feature is associated with the probability model.

At 730, the script selection unit 530 in the script identification unit 250 may receive the scores for the plurality of probability models and select the highest score among the received scores. The script associated with the highest score may be identified as the script for the text region, at 740. In one embodiment, the script selection unit 530 may identify the script if the highest score of the script exceeds a predetermined threshold score. A script ID for the identified script may be output to the language determination unit 260.

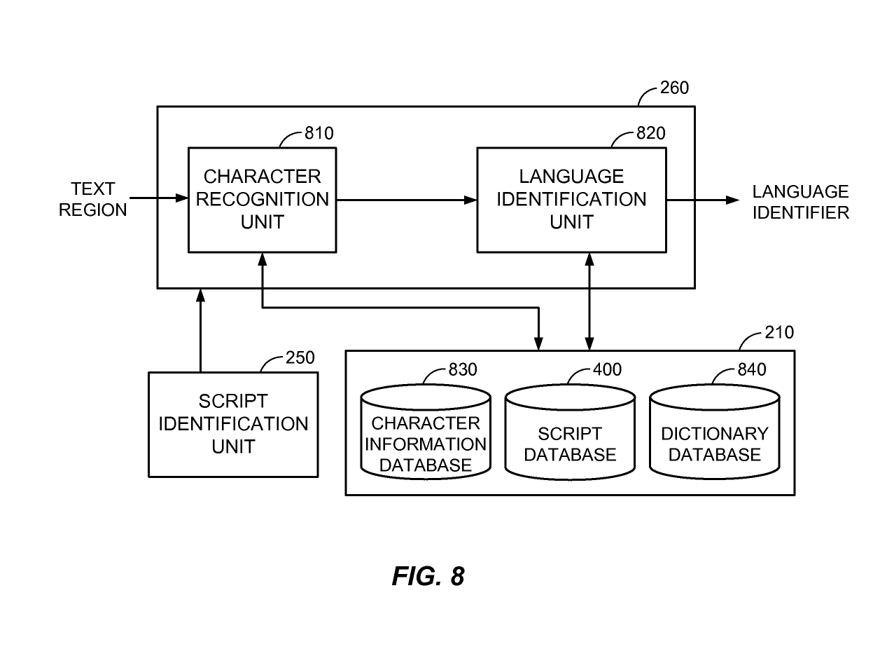

FIG. 8 is a block diagram of the language determination unit 260 configured to determine a language of text in a text region based on a plurality of languages associated with an identified script according to one embodiment of the present disclosure. The language determination unit 260 may include a character recognition unit 810 and a language identification unit 820. The character recognition unit 810 may receive the script ID from the script identification unit 250 and access a character information database 830 in the storage unit 210 that corresponds to the identified script for use in recognizing one or more characters associated with the script.

One or more characters in the text region may be recognized based on the character information database 830 for the identified script using any suitable character recognition schemes such as matrix matching, feature matching, etc. In some embodiments, the character recognition unit 810 may receive the text region from the text region detection unit 240 and parse through the text in the text region to determine character information in the text of the text region. The character information may include pattern or geometric data of one or more characters used in the identified script, images of glyphs representing one or more characters in the script, and/or at least one feature for one or more characters associated with individual glyphs in the script.

In one embodiment, the character recognition unit 810 may recognize one or more characters in the text region by comparing the character information identified from the text in the text region and the character information database 830 associated with the identified script. For example, the character recognition unit 810 may identify patterns or symbols in the text region and compare the patterns or symbols with the pattern or geometric data of a plurality of characters from the character information database 830 that are associated with the identified script. In this case, if a similarity between one or more identified patterns or symbols and pattern or geometric data for a specified character in the script is determined to exceed a predetermined threshold, the patterns or symbols may be recognized as the specified character. The recognized characters may then be output to the language identification unit 820.

The language identification unit 820 may be configured to receive the one or more recognized characters for the text region from the character recognition unit 810. One or more words in the text region may be detected from the recognized characters, and a language associated with each of the detected words or characters may be determined In one embodiment, the language identification unit 820 may detect a string of characters as a word in the text region by detecting any suitable characters, symbols, or spaces that may separate or distinguish words in a script. For example, a word in a text region may be detected when a string of characters ends in a space. Additionally or alternatively, the language identification unit 820 may detect one or more characters that are unique to a language (e.g., an inverted question mark in Spanish) to determine a language associated with the detected characters.

The language identification unit 820 may receive the script ID for the text region from the script identification unit 250 and access the script database 400 in the storage unit 210 to determine one or more languages associated with the identified script. Based on the languages associated with the script, a dictionary database 840 in the storage unit 210 may be accessed to retrieve a plurality of dictionaries for the languages associated with the identified script. For example, if the identified script is Latin, a plurality of dictionaries for English, Spanish, French, etc. that are associated with the Latin script may be retrieved from the storage unit 210. In this case, the plurality of dictionaries for the plurality of Latin-based languages may be combined into a dictionary database for the Latin-based languages. In some embodiments, the language identification unit 820 may detect one or more words in the text region and identify a language associated with each of the words based on a plurality of dictionaries for an identified script. In this process, the language identification unit 820 may compare each of the detected words with the plurality of dictionaries for the identified script to determine a language associated with each of the words. The language identified for each of the words that have been detected in the text region may be output for the user or post-processing in the text recognition unit 270. In another embodiment, if two or more languages are identified for a word, the language for the word may be determined based on one or more languages identified for one or more neighboring words in the text region or neighboring text regions.

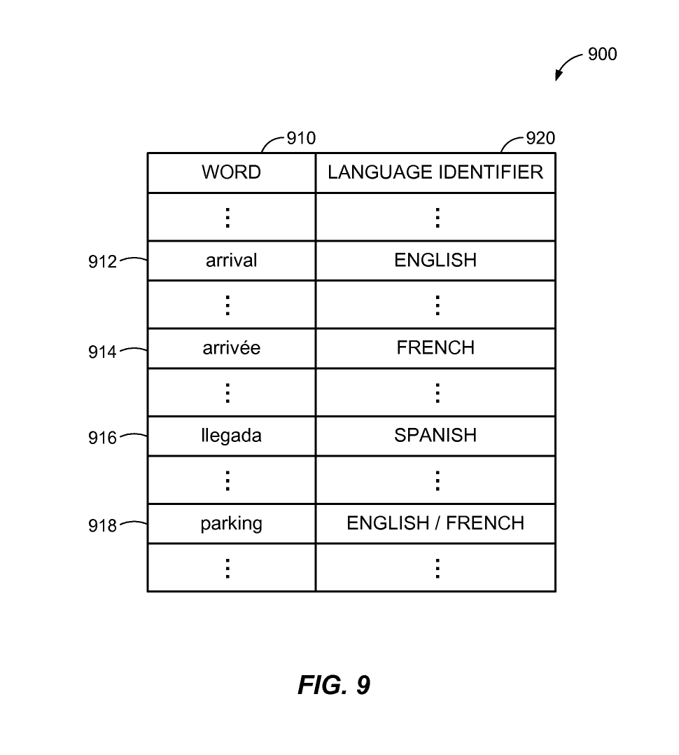

FIG. 9 is a diagram of an exemplary dictionary database 900 for a plurality of Latin-based languages that may be used in determining a language for a word according to one embodiment of the present disclosure. As illustrated, the dictionary database 900 includes a plurality of words for English, Spanish, and French dictionaries. When a word is detected from one or more recognized characters in a text region, the language determination unit 260 may search the dictionary database 900 for the word. When the word is found in the dictionary database 900, the language determination unit 260 may retrieve a language identifier that identifies a language for the word.

As shown, the dictionary database 900 is illustrated as a table having a column for words 910 and a column for language identifiers 920. In the dictionary database 840, a plurality of entries 912, 914, 916, and 918 may be provided for a plurality of exemplary words “arrival,” “arrivée,” “Ilegada,” and “parking,” respectively. The entries 912, 914, 916, and 918 may also provide language identifiers to indicate one or more languages associated with the words. For example, the words “arrival,” “arrivée,” “Ilegada,” and “parking” may be associated with English, French, Spanish, and English/French languages, respectively, for the language identifiers. In the case of the word “parking,” both English and French may be identified as the language identifiers since the word is used in both languages. Although the dictionary database 900 is shown as a table, it may also be implemented in any suitable data structure such as a linked list, an array, a hash table, etc.

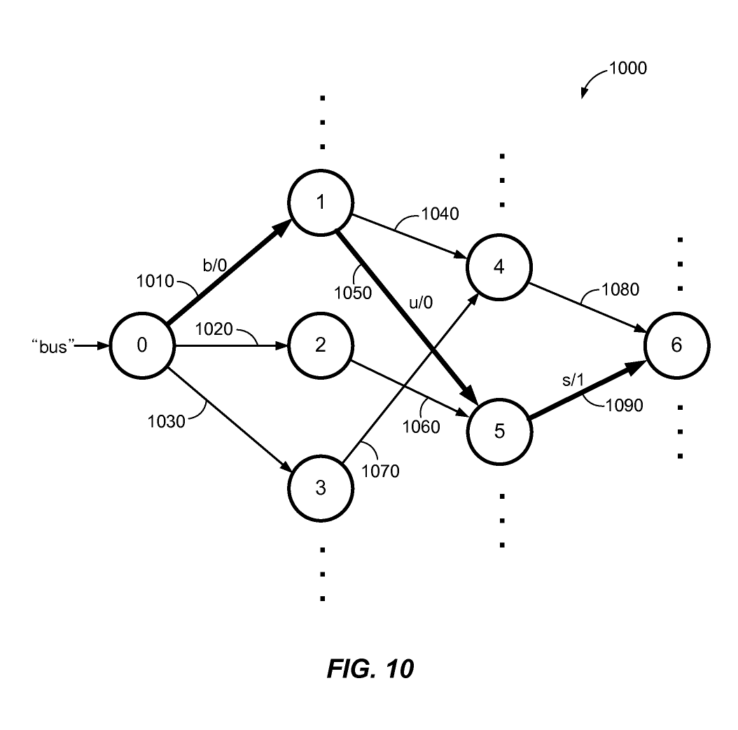

FIG. 10 illustrates a diagram of an exemplary finite state transducer (“FST”) 1000 that may be implemented in the language identification unit 820 for identifying a plurality of Latin-based languages according to one embodiment of the present disclosure. The FST 1000 is a finite state machine including a plurality of states “0” to “638 for use in determining a language for an exemplary input word “bus.” As shown, the states in the FST 1000 may be traversed from an initial state “0” to a final state “6” via a pair of intermediate states “1,” “2,” or “3” and “4” or “5.”

The FST 1000 may be traversed in four different paths defined by the state sequences: states “0,” “1,” “4,” and “6;” states “0,” “1,” “5,” and “6;” states “0,” “2,” “5,” and “6;” and states “0,” “3,” “4,” and “6.” Initially, the initial sate “0” has three outgoing arcs 1010, 1020, and 1030, which are incoming arcs into the intermediate states “1,” “2,” and “3,” respectively. The states “1,” “2,” and “3” have four outgoing arcs 1040, 1050, 1060, and 1070, of which the outgoing arcs 1040 and 1070 are incoming arcs into the state “4” and the outgoing arcs 1050 and 1060 are incoming arcs into the state “5.” The states “4” and “5” have two outgoing arcs 1080 and 1090, respectively, which are incoming arcs into the final state “6.”

Each arc in the FST 1000 may be encoded with a character in the Latin-based languages and a language ID (e.g., “1” for English, “2” for Spanish, “3” for French, etc.) for a candidate word up to a given state traversed in the FST. In one embodiment, the language identification unit 820 may provide the first character “b” in the word “bus” to the initial state “0.” In the illustrated FST 1000, since the character “b” is encoded in the outgoing arc 1010 of the state “0,” the state “1” is then traversed. The outgoing arc 1010 is encoded with a language ID of “0” indicating that no language identifier is associated with the character “b.” At the state “1,” the next character “u” from the word “bus” is received and the language identification unit 820 determines that the character “u” is encoded in the outgoing arc 1050 of the state “1,” which is also the incoming arc 1050 for the state “5.” The outgoing arc 1050 is also encoded with a language ID of “0” indicating that no language identifier is associated with the characters “bu.”

At the penultimate state “5,” the next character “s” from the word “bus” is received, and the language identification unit 820 determines that the character “s” is encoded in the outgoing arc 1090 of the state “5,” which is the incoming arc 1090 for the state “6.” The outgoing arc 1090 is encoded with a language ID “1” indicating that the candidate word is English. The language identification unit 820 then proceeds to the final state “6” and outputs the language ID “1” to indicate that the language of the candidate word “bus” is English.

While the FST 1000 is illustrated for determining a language for the word “bus,” the FST 1000 for a plurality of languages in a script may be constructed by combining a plurality of dictionaries for the languages. By combining the dictionaries, the FST 1000 may function as a unified word decoder for words in the dictionaries. For example, a plurality of Latin-based dictionaries may be combined into a single FST that may be traversed for determining a language of a word. Although the language identification unit 820 determines a language of one or more words using the illustrated FST 1000, it may also employ any suitable databases, dictionaries, finite state machines, or the like that may encode words of any languages of a script or associate words with languages in a script.

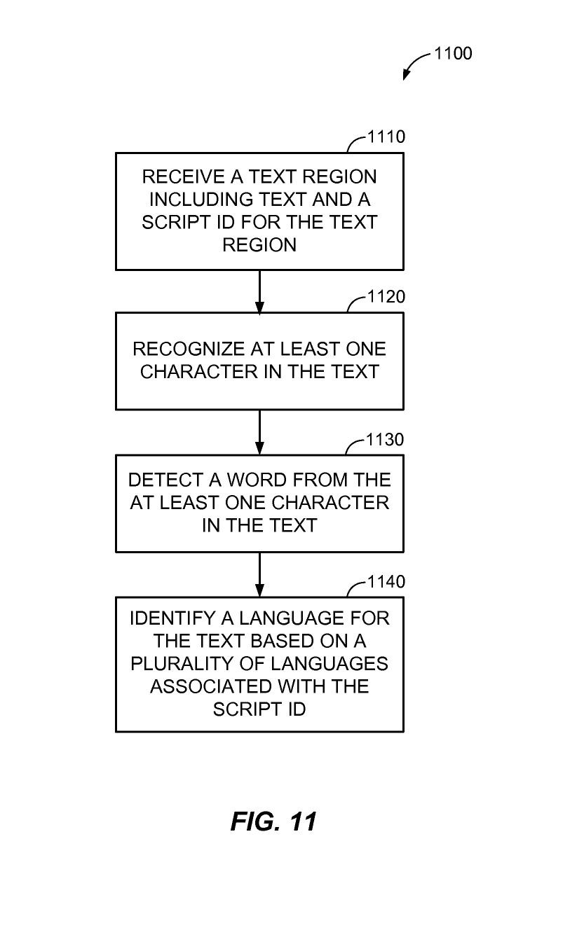

FIG. 11 is a flowchart of a method 1100 for determining a language of text based on a dictionary database associated with an identified script according to one embodiment of the present disclosure. Initially, the character recognition unit 810 in the language determination unit 260 may receive a detected text region from the text region detection unit 240 and a script ID for the text region from the script identification unit 250, at 1110. At 1120, the character recognition unit 810 may recognize at least one character using character information database 830 in the storage unit 210 that corresponds to the script ID.

At 1130, the language identification unit 820 in the language determination unit 260 may receive the at least one recognized character for the text region from the character recognition unit 810 and detect a word in the text region. A language associated with the detected word may be identified based on a plurality of languages associated with the script ID, at 1140. In this process, the language identification unit 820 may determine the plurality of languages associated with the script ID using the script database 400 from the storage unit 210.

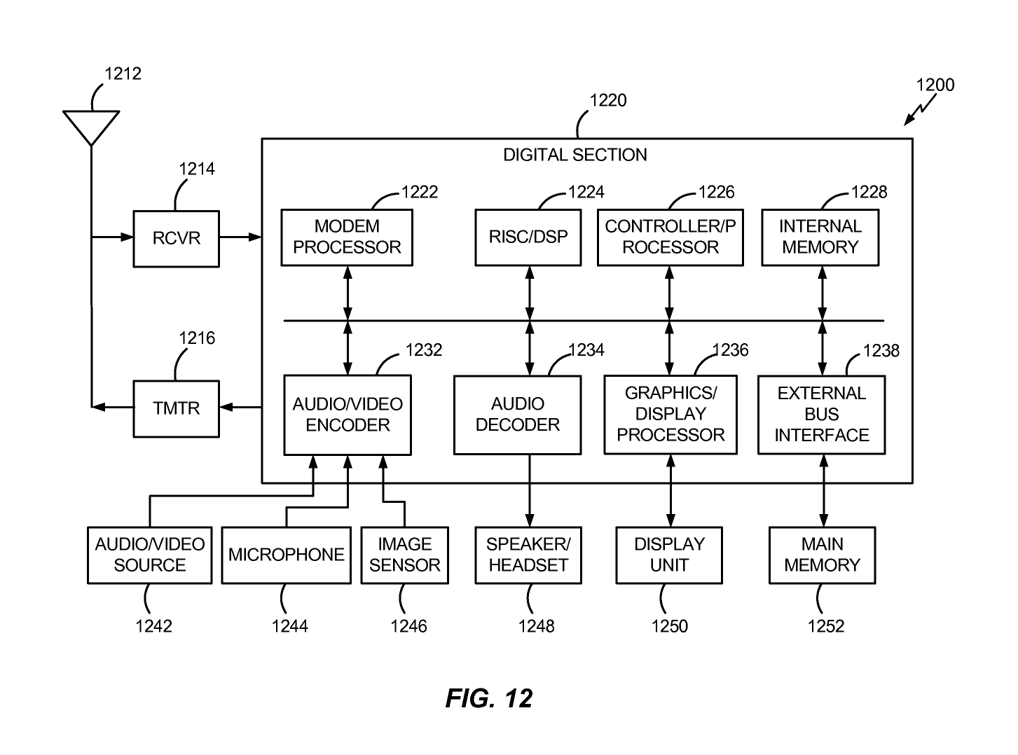

FIG. 12 is a block diagram of an exemplary electronic device 1200 in which the methods and apparatus for identifying a language of text in an image of an object may be implemented, according one embodiment of the present disclosure. The configuration of the electronic device 1200 may be implemented in the electronic devices according to the above embodiments described with reference to FIGS. 1 to 11. The electronic device 1200 may be a cellular phone, a smartphone, a tablet computer, a laptop computer, a terminal, a handset, a personal digital assistant (PDA), a wireless modem, a cordless phone, etc. The wireless communication system may be a Code Division Multiple Access (CDMA) system, a Broadcast System for Mobile Communications (GSM) system, Wideband CDMA (WCDMA) system, Long Tern Evolution (LTE) system, LTE Advanced system, etc. Further, the electronic device 1200 may communicate directly with another mobile device, e.g., using Wi-Fi Direct or Bluetooth.

The electronic device 1200 is capable of providing bidirectional communication via a receive path and a transmit path. On the receive path, signals transmitted by base stations are received by an antenna 1212 and are provided to a receiver (RCVR) 1214. The receiver 1214 conditions and digitizes the received signal and provides samples such as the conditioned and digitized digital signal to a digital section for further processing. On the transmit path, a transmitter (TMTR) 1216 receives data to be transmitted from a digital section 1220, processes and conditions the data, and generates a modulated signal, which is transmitted via the antenna 1212 to the base stations. The receiver 1214 and the transmitter 1216 may be part of a transceiver that may support CDMA, GSM, LTE, LTE Advanced, etc.

The digital section 1220 includes various processing, interface, and memory units such as, for example, a modem processor 1222, a reduced instruction set computer/digital signal processor (RISC/DSP) 1224, a controller/processor 1226, an internal memory 1228, a generalized audio/video encoder 1232, a generalized audio decoder 1234, a graphics/display processor 1236, and an external bus interface (EBI) 1238. The modem processor 1222 may perform processing for data transmission and reception, e.g., encoding, modulation, demodulation, and decoding. The RISC/DSP 1224 may perform general and specialized processing for the electronic device 1200. The controller/processor 1226 may perform the operation of various processing and interface units within the digital section 1220. The internal memory 1228 may store data and/or instructions for various units within the digital section 1220.

The generalized audio/video encoder 1232 may perform encoding for input signals from an audio/video source 1242, a microphone 1244, an image sensor 1246, etc. The generalized audio decoder 1234 may perform decoding for coded audio data and may provide output signals to a speaker/headset 1248. The graphics/display processor 1236 may perform processing for graphics, videos, images, and texts, which may be presented to a display unit 1250. The EBI 1238 may facilitate transfer of data between the digital section 1220 and a main memory 1252.

The digital section 1220 may be implemented with one or more processors, DSPs, microprocessors, RISCs, etc. The digital section 1220 may also be fabricated on one or more application specific integrated circuits (ASICs) and/or some other type of integrated circuits (ICs).

In general, any device described herein may represent various types of devices, such as a wireless phone, a cellular phone, a laptop computer, a wireless multimedia device, a wireless communication personal computer (PC) card, a PDA, an external or internal modem, a device that communicates through a wireless channel, etc. A device may have various names, such as access terminal (AT), access unit, subscriber unit, mobile station, mobile device, mobile unit, mobile phone, mobile, remote station, remote terminal, remote unit, user device, user equipment, handheld device, etc. Any device described herein may have a memory for storing instructions and data, as well as hardware, software, firmware, or combinations thereof.

The techniques described herein may be implemented by various means. For example, these techniques may be implemented in hardware, firmware, software, or a combination thereof. Those of ordinary skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, the various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

For a hardware implementation, the processing units used to perform the techniques may be implemented within one or more ASICs, DSPs, digital signal processing devices (DSPDs), programmable logic devices (PLDs), field programmable gate arrays (FPGAs), processors, controllers, micro-controllers, microprocessors, electronic devices, other electronic units designed to perform the functions described herein, a computer, or a combination thereof.

Thus, the various illustrative logical blocks, modules, and circuits described in connection with the disclosure herein are implemented or performed with a general-purpose processor, a DSP, an ASIC, a FPGA or other programmable logic device, discrete gate or transistor logic, discrete hardware components, or any combination thereof designed to perform the functions described herein. A general-purpose processor may be a microprocessor, but in the alternate, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in software, the functions may be stored on or transmitted over as one or more instructions or code on a computer-readable medium. Computer-readable media include both computer storage media and communication media including any medium that facilitates the transfer of a computer program from one place to another. A storage media may be any available media that can be accessed by a computer. By way of example, and not limited thereto, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Further, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc, where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein are applied to other variations without departing from the spirit or scope of the disclosure. Thus, the disclosure is not intended to be limited to the examples described herein but is to be accorded the widest scope consistent with the principles and novel features disclosed herein.

Although exemplary implementations are referred to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices may include PCs, network servers, and handheld devices.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method, performed by an electronic device, for identifying a language of text in an image of an object, the method comprising:
receiving the image of the object;
detecting a text region in the image, the text region including the text;
identifying a script of the text in the text region, the script being associated with a plurality of languages; and
determining the language for the text based on the plurality of languages associated with the script.

2. The method of claim 1, wherein determining the language for the text comprises: recognizing at least one character in the text; and
identifying the language for the at least one character based on a dictionary database for the plurality of languages.

3. The method of claim 2, wherein a plurality of words is mapped to the plurality of languages in the dictionary database.

4. The method of claim 3, wherein the dictionary database includes a plurality of state sequences for the plurality of words, and wherein the state sequences are encoded with a plurality of language identifiers for the words.

5. The method of claim 4, wherein the plurality of state sequences is traversed in a finite state transducer.

6. The method of claim 1, wherein identifying the script of the text in the text region comprises:
extracting at least one feature from the text region;
determining a plurality of scores for a plurality of scripts based on the at least one feature; and
identifying the script for the text based on the plurality of scores.

7. The method of claim 6, wherein determining the plurality of scores comprises determining the plurality of scores for the at least one feature based on a probability model database classifying the plurality of scripts.

8. The method of claim 7, wherein the probability model database includes a non-text probability model.

9. An electronic device for identifying a language of text in an image of an object, comprising:
a text region detection unit configured to receive the image of the object and detect a text region in the image, the text region including the text;
a script identification unit configured to identify a script of the text in the text region, the script being associated with a plurality of languages; and
a language determination unit configured to determine the language for the text based on the plurality of languages associated with the script.

10. The electronic device of claim 9, wherein the language determination unit comprises:
a character recognition unit configured to recognize at least one character in the text; and
a language identification unit configured to identify the language for the at least one character based on a dictionary database for the plurality of languages.

11. The electronic device of claim 10, wherein a plurality of words is mapped to the plurality of languages in the dictionary database.

12. The electronic device of claim 11, wherein the dictionary database includes a plurality of state sequences for the plurality of words, and wherein the state sequences are encoded with a plurality of language identifiers for the words.

13. The electronic device of claim 12, wherein the plurality of state sequences is traversed in a finite state transducer.

14. The electronic device of claim 9, wherein the script identification unit comprises:
a feature extraction unit configured to extract at least one feature from the text region;
a feature classification unit configured to determine a plurality of scores for a plurality of scripts based on the at least one feature; and
a script selection unit configured to identify the script for the text based on the plurality of scores.

15. The electronic device of claim 14, wherein the feature classification unit is further configured to determine the plurality of scores for the at least one feature based on a probability model database classifying the plurality of scripts.

16. The electronic device of claim 15, wherein the probability model database includes a non-text probability model.

17. A non-transitory computer-readable storage medium comprising instructions for identifying a language of text in an image of an object, the instructions causing a processor of an electronic device to perform the operations of:
receiving the image of the object;
detecting a text region in the image, the text region including the text;
identifying a script of the text in the text region, the script being associated with a plurality of languages; and
determining the language for the text based on the plurality of languages associated with the script.

18. The medium of claim 17, wherein determining the language for the text comprises:
recognizing at least one character in the text; and
identifying the language for the at least one character based on a dictionary database for the plurality of languages.

19. The medium of claim 18, wherein a plurality of words is mapped to the plurality of languages in the dictionary database.

20. The medium of claim 19, wherein the dictionary database includes a plurality of state sequences for the plurality of words, and wherein the state sequences are encoded with a plurality of language identifiers for the words.

21. The medium of claim 20, wherein the plurality of state sequences is traversed in a finite state transducer.

22. The medium of claim 17, wherein identifying the script of the text in the text region comprises:
extracting at least one feature from the text region;
determining a plurality of scores for a plurality of scripts based on the at least one feature; and
identifying the script for the text based on the plurality of scores.

23. The medium of claim 22, wherein determining the plurality of scores comprises determining the plurality of scores for the at least one feature based on a probability model database classifying the plurality of scripts.

24. The medium of claim 23, wherein the probability model database includes a non-text probability model.

25. An electronic device for identifying a language of text in an image of an object, comprising:
means for receiving the image of the object;
means for detecting a text region in the image, the text region including the text;
means for identifying a script of the text in the text region, the script being associated with a plurality of languages; and
means for determining the language for the text based on the plurality of languages associated with the script.

26. The electronic device of claim 25, wherein the means for determining the language for the text comprises:
means for recognizing at least one character in the text; and
means for identifying the language for the at least one character based on a dictionary database for the plurality of languages.

27. The electronic device of claim 26, wherein a plurality of words is mapped to the plurality of languages in the dictionary database.

28. The electronic device of claim 27, wherein the dictionary database includes a plurality of state sequences for the plurality of words, and wherein the state sequences are encoded with a plurality of language identifiers for the words.

29. The electronic device of claim 25, wherein the means for identifying the script of the text in the text region comprises:
means for extracting at least one feature from the text region;
means for determining a plurality of scores for a plurality of scripts based on the at least one feature; and
means for identifying the script for the text based on the plurality of scores.

30. The electronic device of claim 29, wherein the means for determining the plurality of scores comprises means for determining the plurality of scores for the at least one feature based on a probability model database classifying the plurality of scripts, and
wherein the probability model database includes a non-text probability model.
